(19) United States
(12) Patent Application Publication
(10) Pub. No.: US 2018/0253212 A1
(43) Pub. Date: Sep. 6, 2018

(54) System and Methods for Extending Effective Reach of a User's Finger on a Touchscreen User Interface

(71) Applicant: QUALCOMM Incorporated, San Diego, CA (US)

(72) Inventors: Robyn Oliver, San Diego, CA (US); Robert Tartz, San Marcos, CA (US); Shiae Park, San Diego, CA (US); Joel Bernarte, San Diego, CA (US)

(21) Appl. No.: 15/449,713

(22) Filed: Mar. 3, 2017

(51) Int. Cl. G06F 3/0481; G06F 3/0488; G06F 3/0484

(52) U.S. Cl. CPC G06F 3/04812; G06F 3/04817; G06F 3/04842; G06F 3/04883

(57) ABSTRACT

A user interface implemented on a mobile device touchscreen may detect a user input to the touchscreen triggering activation of an expanded reach mode. In an expanded reach mode, implemented functions may include identifying a touch location based on a detected touch event on the touchscreen, identifying a selectable graphical user interface (GUI) object having an edge closest to a touch-extension position that is based on the identified touch location, selecting the identified GUI object as a closest GUI object and displaying a first selection indicator in association with the identified GUI object, and determining whether the identified GUI object has remained the closest GUI object for longer than a predetermined time threshold. If the identified GUI object has remained the closest GUI object longer than a time threshold, activation of the identified GUI object may be enabled. An indication of the touch-extension position may be projected on the touchscreen.

### BACKGROUND

Holding a mobile device and interacting with the Graphical User Interface (GUI) displayed on the touchscreen display of the mobile device with only a thumb may be a preferable mode of using the mobile device under many circumstances.

Current mobile communication devices are configured with many different improvements, including larger touchscreens. Often a user will hold a mobile communication device in one hand, and interact with the graphical user interface (GUI) displayed on the touchscreen using only the thumb of the hand holding the mobile device.

However, as the size of touchscreen displays increases, using the mobile device with one hand may become cumbersome due to the mismatch between hand size and the size of a touchscreen display. That is, for mobile devices that are configured with large touchscreens, many users may find it challenging to reach every point of the display with a finger or thumb of one hand

### SUMMARY

Systems, methods, and devices of various embodiments implement a cursor interface on a touchscreen of a mobile device by detecting a user input to a touchscreen triggering activation of an expanded reach mode, identifying a touch location based on a touch event on the touchscreen, identifying a selectable graphical user interface (GUI) object having an edge closest to a touch-extension position, and selecting the identified GUI object as a closest GUI object and displaying a first selection indicator in association with the identified GUI object. In some embodiments, the touch-extension position may be based on the identified touch location. Some embodiments may further include determining whether the identified GUI object has remained the closest GUI object for longer than a predetermined time threshold, and enabling activation of the identified GUI object in response to determining that the identified GUI object has remained the closest GUI object for longer than a predetermined time threshold.

Some embodiments may further include determining whether the touch event has ended in response to determining that the identified GUI object has not remained the closest GUI object for longer than the predetermined time threshold. Some embodiments may further include exiting the expanded reach mode in response to determining that the touch event has ended. Some embodiments may further include maintaining the first selection indicator displayed in association with the identified GUI object in response to determining that the touch event has not ended.

Some embodiments may further include projecting an indication of the touch-extension position on the touchscreen. In some embodiments, projecting the indication-may include at least one of displaying a visible cursor on the touchscreen at the touch-extension position, and displaying the first selection indicator in association with the identified GUI object.

In some embodiments, enabling activation of the identified GUI object may include displaying a second selection indicator in association with the identified GUI object, and determining whether the touch event has ended. Some embodiments may further include launching an action associated with the identified GUI object and automatically exiting the expanded reach mode in response to determining that the touch event has ended.

In some embodiments, the first selection indicator associated with the identified GUI object may be a border surrounding the identified GUI object. In some embodiments, displaying the second selection indicator in association with the identified GUI object may include displaying a thicker version of the first selection indicator.

In some embodiments, displaying the second selection indicator in association with the identified GUI object may include displaying a shape surrounding the identified GUI object, in which the shape is different than that of the border of the first selection indicator. In some embodiments, identifying the touch location may include identifying an initial touch location, determining whether movement of a user's finger across the touchscreen is detected, and identifying an updated touch location in response to determining that movement of a user's finger across the touchscreen is detected. Some embodiments may further include projecting an indication of the touch extension position on the touchscreen by calculating an initial touch-extension position at a predetermined offset from the initial touch location, calculating a vector representing updated touch location, and calculating an updated touch-extension position by applying the vector and a scaling factor to the initial touch-extension position.

In some embodiments, the predetermined offset from the initial touch location may be 3 cm toward the top of the mobile device. In some embodiments, identifying the initial touch location may include identifying a touch area associated with the detected touch event, computing an equation of a shape that best fits a border of the touch area, and identifying a center point of the shape that best fits the border of the touch area.

In some embodiments, the first selection indicator may be a visual indication displayed on the touchscreen. In some embodiments, the visual indication displayed on the touchscreen may be an icon that tracks the touch-extension position on the touchscreen. Some embodiments may further include determining whether movement of a user's finger across the touchscreen is detected upon activation of the expanded reach mode, and playing, on the touchscreen display, an animation demonstrating how to control the indication of the touch extension in the expanded reach mode in response to determining that motion of the user's finger across the touchscreen is detected.

Various embodiments include a computing device configured with a touchscreen and including a processor configured with processor-executable instructions to perform operations of the methods summarized above. Various embodiments also include a non-transitory processor-readable medium on which is stored processor-executable instructions configured to cause a processor of a computing device to perform operations of the methods summarized above. Various embodiments include a computing device having means for performing functions of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the claims.

FIG. 1A is a block diagram illustrating a mobile device suitable for use with various embodiments.

FIG. 1B is a block diagram illustrating an example system for implementing a cursor system on a device according to various embodiments.

FIG. 2 is an illustration of conventional single-handed use of a mobile device according to various embodiments.

FIG. 3A is a schematic diagram illustrating example parameters used to calculate an initial touch location according to various embodiments.

FIG. 3B is an illustration of an example touchscreen display showing parameters used to determine an initial touch-extension position according to various embodiments.

FIG. 3C is an illustration of an example touchscreen display showing parameters used to determine cursor movement according to various embodiments.

FIGS. 4A and 4B are illustrations of an example touchscreen display showing implementation of the expanded reach mode according to various embodiments.

FIG. 5 is a process flow diagram illustrating an example method for implementing the expanded reach mode according to various embodiments.

FIGS. 6A-6C are process flow diagrams illustrating an example method for implementing the expanded reach mode according to various embodiments.

### DETAILED DESCRIPTION

The various embodiments will be described in detail with reference to the accompanying drawings. Wherever possible, the same reference numbers will be used throughout the drawings to refer to the same or like parts. References made to specific examples and implementations are for illustrative purposes, and are not intended to limit the scope of the claims.

Systems, methods, and devices of the various embodiments improve mobile device user experience by providing an expanded-reach mode for touchscreen-enabled devices. In various embodiments, a cursor interface in the expanded reach mode may mitigate the inconvenience of the mismatch between the size of the display and the size of the user's hand An indication of an extension of the touch (e.g., a cursor) may be controlled by a single finger (e.g., thumb or other finger), and may interact with GUI elements displayed on the touchscreen display. This may include GUI elements that are not easily reachable by a finger or thumb during single-hand use. Various embodiments effectively provide an extension of the touch of a finger or thumb during use by providing an indication of an active point on the touchscreen associated with the user's touch. In some embodiments, the indication may be cursor, while in other embodiments no cursor will be presented and other types of visible indications (e.g., shading, local magnification, local highlighting, etc.) of the extension of the touch may be presented at a touch-extension position on the touchscreen or GUI. For ease of reference, various types of indications of the extension of touch are collectively referred to herein as a “cursor.” However, the term “cursor” is not intended to limit the scope of the disclosure or the claims to a particular type of indication. Further, in some embodiments, no visible indication of the extension of the active point may be provided on the touchscreen.

In operation, a user may activate the expanded reach mode on a mobile device, such as by performing an assigned gesture or touch on the touchscreen. For example, activation may be triggered upon detecting a long thumb press, a particular tracing gesture, or other recognizable interaction on the touchscreen. When the expanded reach mode is activated, an indication of a touch-extension position may be presented through the user interface, such as a visual indication (e.g., GUI object/icon) displayed on the touchscreen. Properties of a user's finger or thumb on the touchscreen may be calculated by a processor of the mobile device. A processor using signals received from the touchscreen may calculate an initial touch location. The initial touch location may be calculated, for example, as a center point of a touch area, as highest pressure point within a touch area, etc. The initial position of the cursor may be determined using the calculated initial touch location. In some embodiments, the position of the cursor may be initially positioned at a predetermined distance above the determined initial touch position.

In some embodiments, movement of the cursor from the initial position to a second position may be determined when dragging of the user's finger is detected on the touchscreen by a processor of the mobile device. Based on an updated touch location on the mobile device, an updated touch-extension position may be calculated by the processor based on the length of a vector from the initial touch location to an updated touch-extension position resulting from the dragging of the digit on the touchscreen display.

In the expanded reach mode, a “nearest neighbor” approach may be implemented in which the mobile device processor selects the nearest selectable GUI object to the cursor location. In some embodiments, the nearest selectable object may be determined based on the nearest edge among all selectable GUI objects/elements of the user interface. Thus, in the expanded reach mode, a user does not need to move the cursor within a particular distance of a selectable GUI object. Rather, the user only needs to move the cursor so that no other GUI objects are closer.

A first selection indicator may be displayed on the touchscreen with respect to the GUI object nearest to the cursor. For example, the first selection indicator may be a border or shape surrounding the GUI object that the processor determines to be closest to the cursor. In some embodiments, the first selection indicator, in combination with the position of GUI objects, may serve as an indicator of the cursor location to the user. Once the GUI object nearest to the cursor has been selected for a first predetermined length of time (e.g., 500 ms), a second selection indicator may be displayed on the touchscreen with respect to the GUI object nearest to the cursor. For example, the second selection indicator may be a thickened border or shape surrounding the GUI object nearest to the cursor. In another example, the second selection indicator may be a different border or shape surrounding the GUI object nearest to the cursor.

Once the second selection indicator has been applied, the user may activate the object. The activation may occur through a gesture, including, for example, release of the touch on the touchscreen (i.e., lifting the user's finger), tapping, swiping, and/or other gestures. The activation of the GUI object may cause, for example, the processor of the mobile device to launch of a corresponding application or another action. Upon activation of the GUI object, the mobile device may automatically exit the one-handed use mode.

If the cursor is moved due to the user's finger being dragged on the touchscreen display after the second selection indicator has been applied (i.e., instead of an activation gesture), the current GUI object may remain selected as long as it is the selectable GUI object closest to the cursor. Once a new GUI object is identified as the neighboring object nearest to the cursor, the first and second selection indicators may be removed from the current GUI object, and a first selection indicator may be applied to the new GUI object. Thus, the user may move the cursor from object to object by sliding a finger/thumb on the touchscreen display until a desired GUI object is highlighted.

As used herein, the term “mobile device” refers to any of a variety of mobile computing devices of a size in which single handed operation is possible, such as cellular telephones, tablet computers, personal data assistants (PDAs), palm-top computers, wireless electronic mail receivers and cellular telephone receivers, multimedia Internet enabled cellular telephones, multimedia enabled smartphones (e.g., Android® and Apple iPhone®), and similar electronic devices that include a programmable processor, memory, and a touchscreen display/user interface.

The terms “GUI object” and “GUI element” may be used interchangeably herein to refer to visual labels or navigation components displayed through a GUI. Further, the various embodiments relate to selectable GUI objects, which may be referenced merely as “GUI objects” in the descriptions herein.

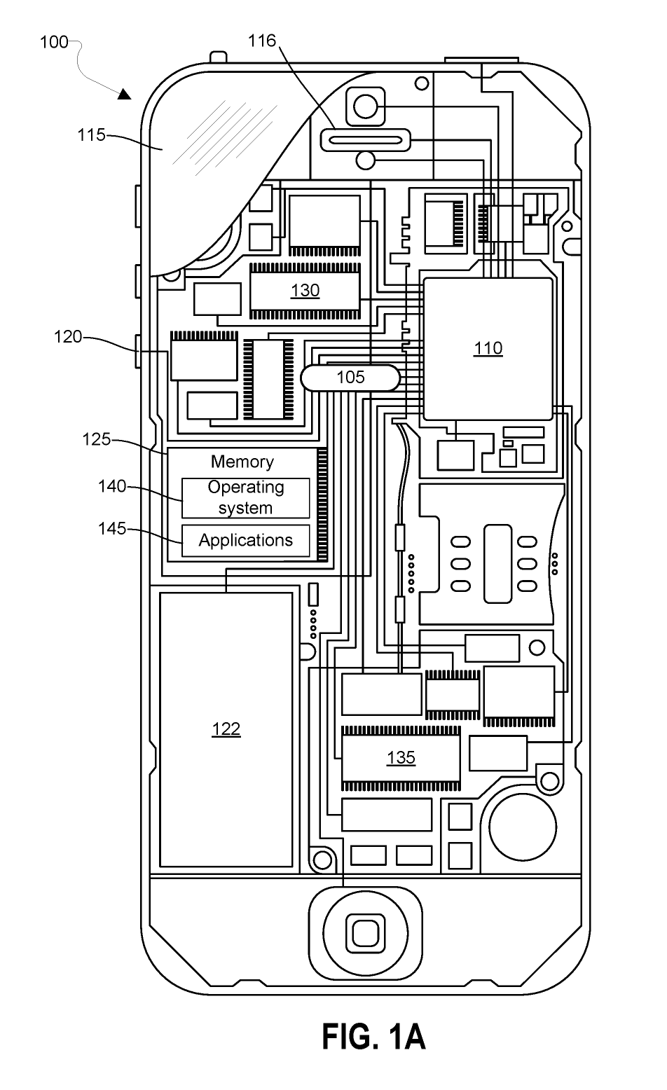

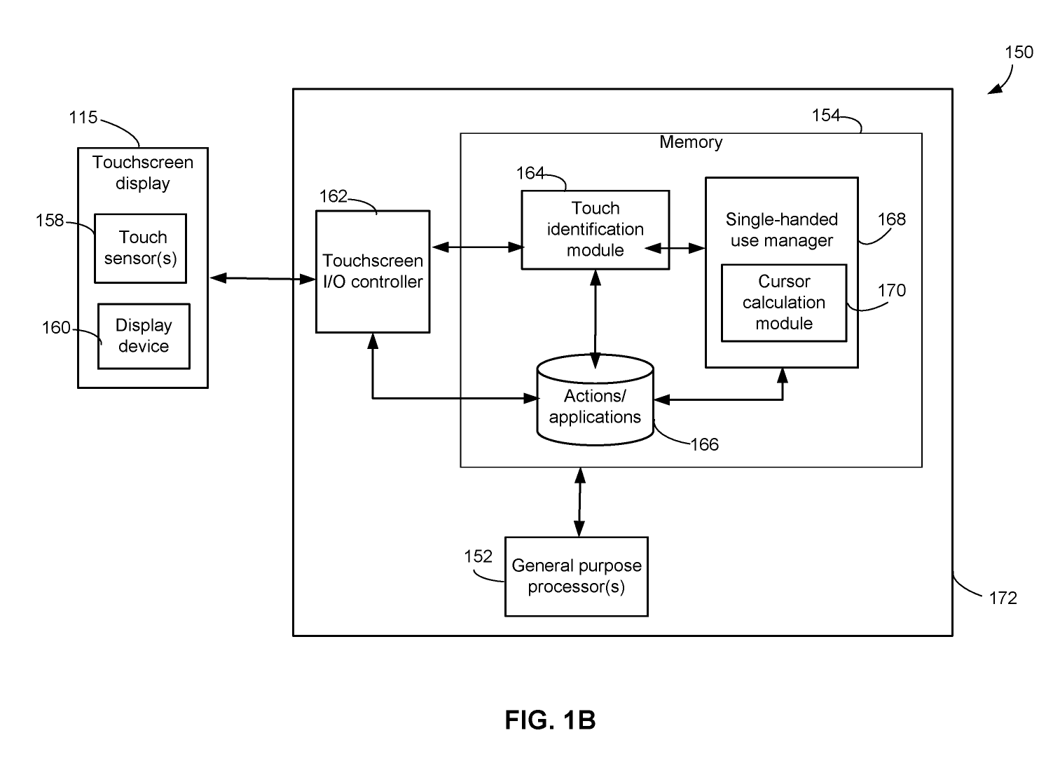

FIG. 1A is a component diagram of a mobile device that may be adapted for a cursor interface in the single-handed mode. Smartphones are particularly suitable for implementing the various embodiments, and therefore are used as examples in the figures and the descriptions of various embodiments. However, the claims are not intended to be limited to smartphones unless explicitly recited and encompass any mobile device of a size suitable for single handed use.

A mobile device 100 is shown including hardware elements that can be electrically coupled via a bus 105 (or may otherwise be in communication, as appropriate). The hardware elements may include one or more processor(s) 110, including without limitation one or more general-purpose processors and/or one or more special-purpose processors (such as digital signal processor (DSP) chips, graphics acceleration processors, and/or the like), one or more input devices, which include a touchscreen 115, and further include without limitation a keyboard, keypad, camera, microphone and/or the like; and one or more output devices 120, which include without limitation an interface 120 (e.g., a universal serial bus (USB)) for coupling to external output devices, a display device, a speaker 116, and/or the like.

The mobile device 100 may further include (and/or be in communication with) one or more non-transitory storage devices 125, which can include, without limitation, local and/or network accessible storage, and/or can include, without limitation, solid-state storage device such as a random access memory (RAM) and/or a read-only memory (ROM), a disk drive, a drive array, an optical storage device, which can be programmable, flash-updateable, and/or the like. Such storage devices may be configured to implement any appropriate data stores, including without limitation, various file systems, database structures, and/or the like.

The mobile device 100 may also include a communications subsystem 130, which may include without limitation a modem, a network card (wireless or wired), a wireless communication device and/or chipset (such as a Bluetooth device, an 802.11 device, a Wi-Fi device, a WiMAX device, cellular communication facilities, etc.), and/or the like. The communications subsystem 130 may permit data to be exchanged with a network, other devices, and/or any other devices described herein. In some embodiments, the mobile device 100 may further include a memory 135, which may include a RAM or ROM device, as described above.

The mobile device 100 may include a power source 122 coupled to the processor 110, such as a disposable or rechargeable battery. The rechargeable battery may also be coupled to the peripheral device connection port to receive a charging current from a source external to the mobile device 100.

The mobile device 100 may also include software elements, shown as being currently located within the working memory 135, including an operating system 140, device drivers, executable libraries, and/or other code, such as one or more application programs 145, which may include or may be designed to implement methods, and/or configure systems of various embodiments. Merely by way of example, one or more procedures described with respect to the method(s) discussed below may be implemented as code and/or instructions executable by the mobile device 100 (and/or a processor(s) 110 within the mobile device 100). In an embodiment, such code and/or instructions may be used to configure and/or adapt a general purpose processor to perform one or more operations in accordance with the described embodiments.

A set of these instructions and/or code may be stored on a non-transitory computer-readable storage medium, such as the storage device(s) 125 described above. In some cases, the storage medium may be incorporated within the mobile device 100. In other embodiments, the storage medium may be separate from the mobile device 100 (e.g., a removable storage mediums), and/or provided in an installation package, such that the storage medium can be used to program, configure, and/or adapt a general purpose computer with the instructions/code stored thereon. These instructions may take the form of executable code, which is executable by the mobile device 100 and/or may take the form of source and/or installable code, which, upon compilation and/or installation on the mobile device 100 (e.g., using any of a variety of generally available compilers, installation programs, compression/decompression utilities, etc.), then takes the form of executable code. Application programs 145 may include one or more applications adapted for a cursor interface. The functionality of the applications may be alternatively implemented in hardware or different levels of software, such as an operating system (OS) 140, a firmware, a computer vision module, etc.

FIG. 1B is a functional block diagram of a mobile device 150 showing elements that may be used for implementing a cursor interface according to various embodiments. The mobile device 150 may be similar to the mobile device 100 described with reference to FIG. 1A. As shown, the mobile device 150 may include at least one controller, such as general purpose processor(s) 152 (e.g., 110), which may be coupled to at least one memory 154 (e.g., 135). The memory 154 may be a non-transitory tangible computer readable storage medium that stores processor-executable instructions. The memory 154 may store the operating system (OS) (140), as well as user application software and executable instructions.

The mobile device 150 may also include a touchscreen display 115 that includes one or more touch sensor(s) 158 and a display device 160. The touch sensor(s) 158 may be configured to sense the touch contact when the user's finger touches the touch-sensitive surface. For example, the touch-sensitive surface may be based on capacitive sensing, optical sensing, resistive sensing, electric field sensing, surface acoustic wave sensing, pressure sensing and/or other technologies. In some embodiments, the touchscreen display 115 may be configured to recognize touches, as well as the position and magnitude of touches on the touch sensitive surface.

The display device 160 may be a light emitting diode (LED) display, a liquid crystal display (LCD) (e.g., active matrix, passive matrix) and the like. Alternatively, the display device 160 may be a monitor such as a monochrome display, color graphics adapter (CGA) display, enhanced graphics adapter (EGA) display, variable-graphics-array (VGA) display, super VGA display, cathode ray tube (CRT), and the like. The display device may also correspond to a plasma display or a display implemented with electronic inks.

In various embodiments, the display device 160 may generally be configured to display a graphical user interface (GUI) that enables interaction between a user of the computer system and the operating system or application running thereon. The GUI may represent programs, files and operational options with graphical images. The graphical images may include windows, fields, dialog boxes, menus, icons, buttons, cursors, scroll bars, etc. Such images may be arranged in predefined layouts, or may be created dynamically to serve the specific actions being taken by a user. During operation, the user may select and activate various graphical images in order to initiate functions and tasks associated therewith. By way of example, a user may select a button that opens, closes, minimizes, or maximizes a window, or an icon that launches a particular program.

The touchscreen display in the various embodiments may be coupled to a touchscreen input/output (I/O) controller 162 that enables input of information from the sensor(s) 158 (e.g., touch events) and output of information to the display device 160 (e.g., GUI presentation). In various embodiments, the touchscreen I/O controller may receive information from the touch sensor(s) 158 based on the user's touch, and may send the information to specific modules configured to be executed by the general purpose processor(s) 152 in order to interpret touch events. In various embodiments, single point touches and multipoint touches may be interpreted. The term “single point touch” as used herein refers to a touch event defined by interaction with a single portion of a single finger (or instrument), although the interaction could occur over time. Examples of single point touch input include a simple touch (e.g., a single tap), touch-and-drag, and double-touch (e.g., a double-tap-two taps in quick succession). A “multi-point touch” may refer to a touch event defined by combinations of different fingers or finger parts.

In various embodiments, the mobile device 100 may include other input/output (I/O) devices that, in combination with or independent of the touchscreen display 115, may be configured to transfer data into the mobile device 100. For example, the touchscreen I/O controller 162 may be used to perform tracking and to make selections with respect to the GUI on the display device 160, as well as to issue commands. Such commands may be associated with zooming, panning, scrolling, paging, rotating, sizing, etc. Further, the commands may also be associated with launching a particular program, opening a file or document, viewing a menu, making a selection, executing instructions, logging onto the computer system, loading a user profile associated with a user's preferred arrangement, etc. In some embodiments, such commands may involve triggering activation of a single-handed use manager according to various embodiments.

When touch input is detected by touch sensors 158 and associated signals received through the touchscreen I/O controller 162, the general purpose processor 152 may implement one or more program modules stored in the memory 154 to identify/interpret the touch event and control various components of the mobile device 100. For example, a touch identification module 164 may identify events that correspond to commands for performing actions in applications 166 stored in the memory 154, modifying GUI elements shown on the display device 160, modifying data stored in the memory 154, etc. In some embodiments, the touch identifier module may identify an input as a single point touch event on the touchscreen display 115.

In some embodiments, the touch input may be identified as triggering the expanded reach mode, for example, based on gesture recognition. Once in the expanded reach mode, control of the cursor in the mobile device may be passed to a single-handed use manager 168. In various embodiments, the single-handed use manager 168 may be a program module stored in the memory 154, which may be executed by one or more controllers (e.g., general purpose processor(s) 152).

In various embodiments, cursor movement may be controlled by the user moving a single finger on a touch sensitive surface of the touchscreen display 115. When the expanded reach mode is not active, such cursor tracking may involve interpreting touch events by the touch identifier module 164, and generating signals for producing corresponding movement of a cursor icon on the display device 160.

While the expanded reach mode is active, the single-handed use manager 168 may interpret touch events and generate signals for producing scaled movements of the cursor icon presented on the display device 160. In various embodiments, interpreting touch events while in the expanded reach mode may involve extracting features from the touch data (e.g., number of touches, position and shape of touches, etc.), as well as computing parameters (e.g., touch pressure and/or best fit ellipse to touch area, etc.). In various embodiments, such touch data and parameters may be created by the touchscreen I/O interface 162. Further, a cursor calculation module 170 may use the measured/sensed touch data and parameters obtained from the touchscreen I/O interface 162 to determine a cursor location. Other functions, including filtering signals and conversion into different formats, as well as interpreting touch event when the expanded reach mode is not activated, may be performed using any of a variety of additional programs/modules stored in the memory 154.

In some embodiments, the general purpose processor(s) 152, memory 154, and touchscreen I/O controller 162 may be included in a system-on-chip device 172. The one or more subscriber identity modules (SIMs) and corresponding interface(s) may be external to the system-on-chip device 172, as well as various peripheral devices (e.g., additional input and/or output devices) that may be coupled to components of the system-on-chip device 172, such as interfaces or controllers.

Holding a mobile device and interacting with the GUI displayed on the touchscreen display of the mobile device to extend the user's reach using one or more finger/hand (e.g., the thumb of a hand holding the mobile device, or other fingers of one or both hands holding the device) may be a preferable mode of using the mobile device under many circumstances. However, as the sizes of the touchscreen displays of mobile devices increase, such single-digit use may become cumbersome or even impossible. The problems of reaching all portions of the touchscreen display, especially the top region of the touchscreen display, with the thumb or other finger of a hand holding the mobile device may become a challenge, especially for those with small hands.

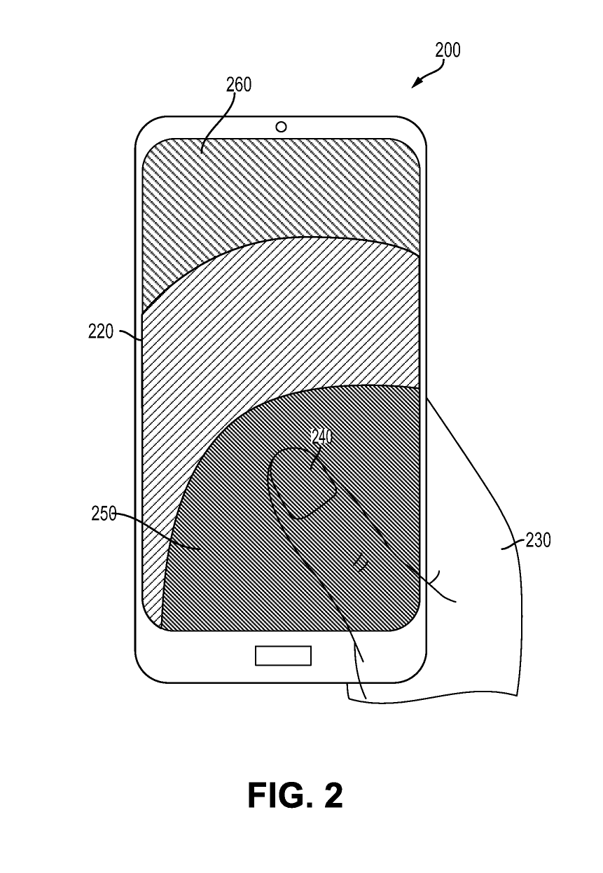

FIG. 2 is an illustration of conventional single-handed use of a mobile device 200. The mobile device 200 may be similar to the mobile devices 100, 150 described with reference to FIGS. 1A-1B. The mobile device 200 may be configured with a touchscreen display 220 (e.g., display device 160). Holding the mobile device 200 in one hand 230 and interacting with the GUI displayed on the touchscreen display 220 of the mobile device with only the thumb 240 (or other finger) of hand 230 may be a preferable mode of using the mobile device under many circumstances. However, the larger the touchscreen display 220, the more difficult it is to reach every corner with a single finger. The upper region 260 of the touchscreen display 220 may be especially difficult to reach with the thumb 240 (or other finger) of the hand 230 holding the mobile device. For example, FIG. 2 illustrates a first region 250 of the touchscreen display 220 that is easily reachable by the thumb 240, and a second region 260 of the touchscreen display 220 that is difficult to reach by the thumb 240.

The various embodiments utilize additional inputs made available by processing touch event data generated by the touchscreen to implement a cursor interface in order to overcome the inconveniences of single-handed use of conventional mobile devices caused by the mismatch between the sizes of the touchscreen display and users' hand The cursor may interact with different elements of the GUI, which may show a visual indication of the touch-extension position. The cursor may be movable in the whole region of the GUI by movement of a user's finger across the touchscreen display. With a mobile device that implements various embodiments, the user may interact with elements of the GUI on the touchscreen display that are not easily reachable during one-handed control in normal operation.

The cursor interface may be controlled by any of a number of properties associated with a user's single-point touch. In various embodiments, the cursor may be controlled using any of a number of mechanisms, depending on the particular configurations, settings, and capabilities of the mobile device. In some embodiments, the touch-extension position may be implemented by projecting a virtual point onto the touchscreen in which the location is calculated based on data from the touchscreen. For example, the initial touch-extension position may be established based on an initial touch location, such as at a predefined distance from the center or other point of an initial touch area. In some embodiments, the initial touch area may be calculated, for example, as an approximate area of the finger in contact with the touchscreen surface. Therefore, a shape approximated by the initial touch area (e.g., an ellipse) may be identified, and the center point calculated for an initial touch location. In some embodiments, the mobile device may be configured with a pressure-sensitive touchscreen capable of measuring touch pressure. Such pressure-sensitive touchscreens may utilize a combination of capacitive touch and infrared light sensing to determine the touch force. In such embodiments, the initial touch location may instead be identified by detecting the highest pressure point within the initial touch area.

In some embodiments, the calculation of the location of the cursor may use techniques illustrated by the following equations. However, the following equations are provided only as examples of calculations that may be implemented in various embodiments. However, other calculation methods may be used in various embodiments. Thus, the following example equations provide models of relationships between components that may be implemented in various embodiments.

As discussed above, while in the expanded reach mode is the properties of input to the touchscreen may be determined by sensing/measuring data of a touch location associated with the user's finger (e.g., thumb) on the touchscreen (i.e., “touch data”). In various embodiments, such touch data may include the location of points forming the boundary of the touch area, and a center of the touch area. In some embodiments, the properties derived from the touch data may include an ellipse function that best fits the boundary of the touch area, and which may be identified using a nonlinear regression analysis. For example, a best fitting ellipse may be defined using Equation 1:

$$( \frac{{x}^{2}}{{a}^{2}} ) + ( \frac{{y}^{2}}{{b}^{2}} ) = 1 \qquad Eq . 1$$

where a represents the semi-major axis and b represents the semi-minor axis of the ellipse, with the semi-major and semi-minor axes aligning on x and y Cartesian axes in which the ellipse center is at the origin point (0,0). In a rotated system (i.e., rotated by an angle θ from the x and y axes), the best fitting ellipse may be defined using Equation 2:

$$( \frac{{x}^{′2}}{{a}^{2}} ) + ( \frac{{y}^{′2}}{{b}^{2}} ) = 1 \qquad Eq . 2$$

where a represents the semi-major axis and b represents the semi-minor axis of the ellipse, with the semi-major and semi-minor axes aligning on rotated x′ and y′ axes in which the ellipse center is still at the origin point (0,0).

In various embodiments, the major axis of the best fitting ellipse function is equal to 2a and the minor axis is equal to 2b. The center point of the ellipse may be identified by calculating the intersection of the major and minor axes, which may be represented as line segments between points on the ellipse function in a coordinate system representing touchscreen interface (X1, Y1).

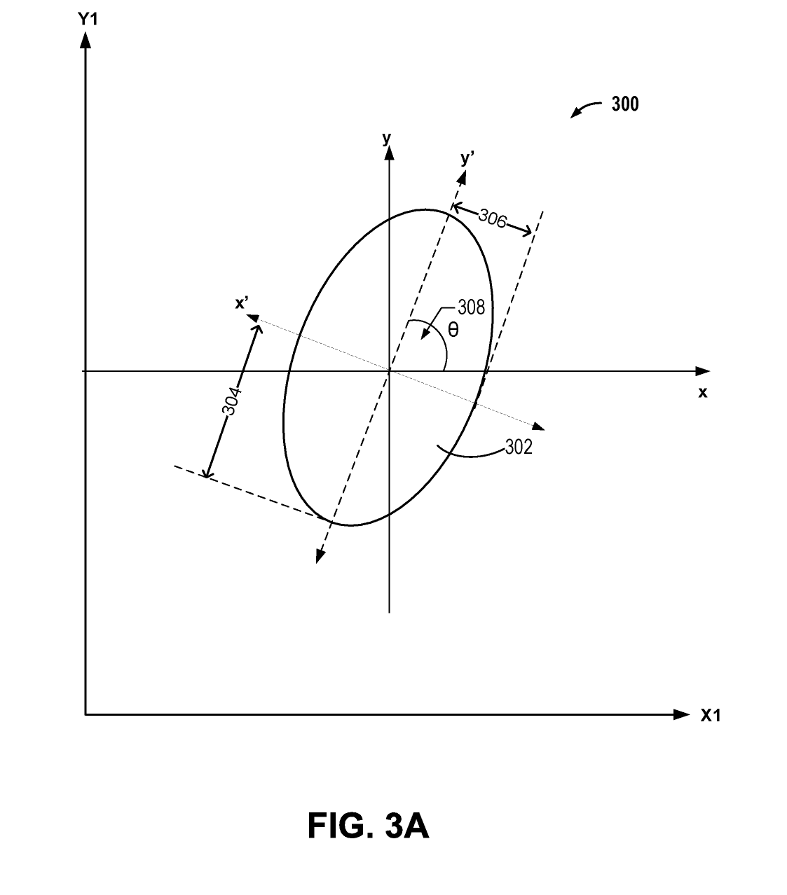

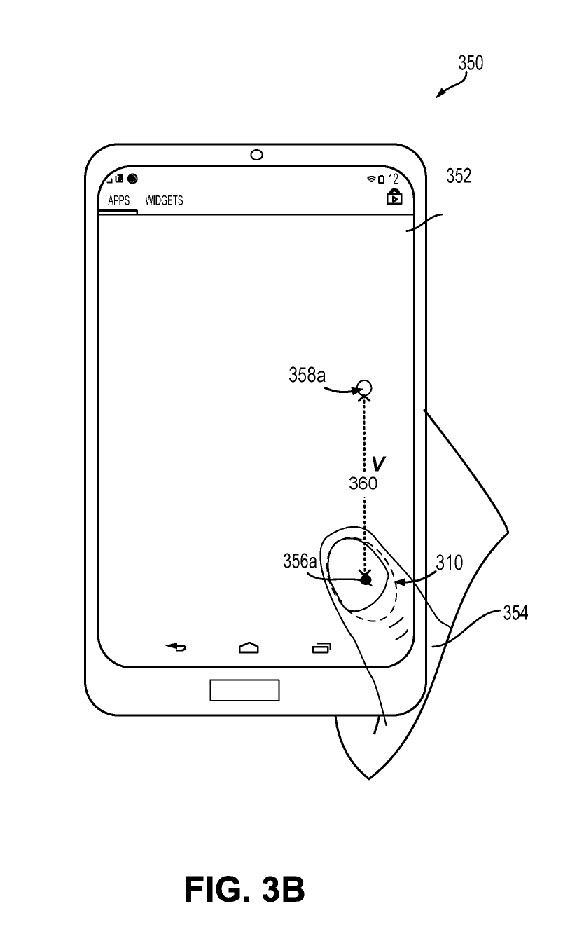

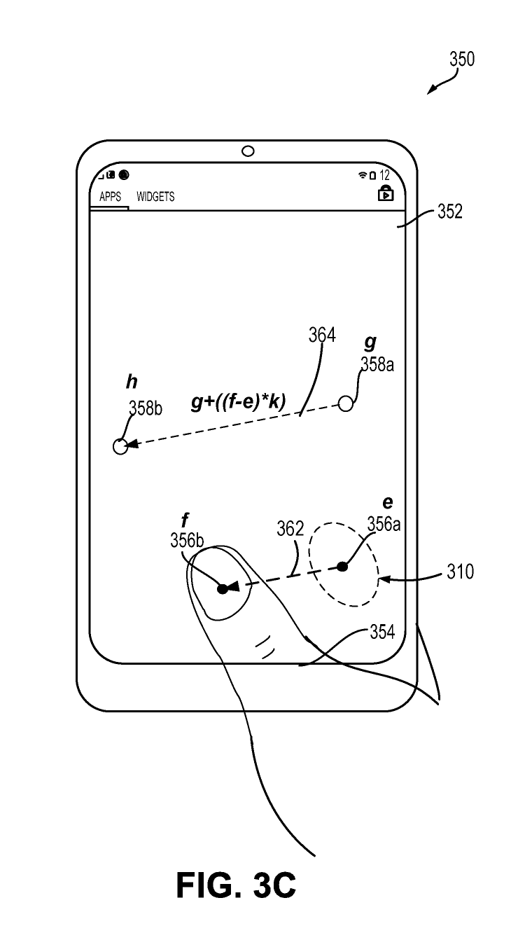

FIG. 3A is a diagram showing an example ellipse function 300 corresponding to a touch area of a user's finger in various embodiments. Conventional touchscreen technologies provide only the positioning (i.e., x, y coordinates) of the touch events. The ellipse function 300 may fitted to an approximate touch area 302, and characterized based on a-semi-major axis 304, and semi-minor axis 306. In addition, a rotational angle 308 (θ) may be determined between the positive x-axis and a line segment corresponding to the semi-major axis 304 of the touch area 302. A coordinate system for the touchscreen interface (X1, Y1) is also shown, which may enable the center point of the best fit ellipse to be mapped to the touchscreen.

The cursor may be displayed on the touchscreen at a position calculated based on the touch location. In some embodiments, the touch-extension position may be calculated as a vector from the initial touch location, which may be calculated using the various touch properties. An indication may be presented on the touchscreen display to represent the position of the cursor. For example, a visual indication (e.g., an icon, color pattern, etc.) may be displayed on the touchscreen, and may provide tracking for the current cursor location on the interface. In another example, the visual indication may be a color gradient. In some embodiments, a tactile indication of the touch-extension position may be used, such as through haptic feedback.

In various embodiments, touch properties used to calculate the touch-extension position may be represented as vectors. In some embodiments, the initial position of the cursor may be calculated by vertically translating an initial touch location. For example, the cursor may be positioned a preset distance in the y-axis direction (e.g., 3 cm) from the coordinates of the center point of the best fit ellipse.

In various embodiments, reference to a particular position and/or location on a touchscreen interface may describe an event in real space that is represented as a point in a two-dimensional coordinate system mapped to the touchscreen. To facilitate calculations that instruct the single-handed use manager 168 and/or cursor calculation module 170 position, reference to the particular position and/or location on the touchscreen interface may also describe a mathematical vector from a reference point (i.e., a vector origin point) in the two-dimensional coordinate system to such point representing the event in real space.

FIG. 3B illustrates a representative determination of the initial touch-extension position on a mobile device 350. According to various embodiments, the mobile device 350 may be similar to the mobile devices 100, 150, 200 described with reference to FIGS. 1A-2. Referring to FIGS. 1-3A, the mobile device 350 may be configured with a touchscreen display 352 (e.g., 160, 220), and a user may interact with the GUI displayed on the touchscreen display 352 with only one finger 354. On the touchscreen display 352, the initial touch location 356a is identified as the center point of the ellipse (e.g., 300) best fitting the boundary of the initial touch area 310. The coordinates of the initial touch location 356a may be translated into a touchscreen coordinate system (X1, Y1). An initial touch-extension position 358a may be established by adding a Y1-value (v) to the coordinates of the center point 356a, which may correspond to a preset distance 360 on the touchscreen interface. That is, where the initial touch location 356a has coordinates of (X1, Y1), the coordinates of the initial touch-extension position 358a may be (X1, Y1+v).

In some embodiments, once movement of the user's finger across the touchscreen surface is detected, a resulting updated touch location may be used to calculate a corresponding updated touch-extension position. For example, the updated cursor location may be calculated using Equation 3:

Updated cursor location=g+((f−e)*k) Eq. 3

where f represents the initial touch location, e represents the updated touch location, g represents the initial touch-extension position, and k is a scaling factor so that the cursor is able to cover the entire touchscreen. In various embodiments, the values f, e, and g may represent vectors from a vector origin point on the touchscreen interface to the initial touch location, updated touch location, and initial touch-extension position, respectively. In various embodiments, the vector origin point may correspond to any of a number of arbitrary locations on the touchscreen (e.g., a center of the touchscreen, any of the corners, etc.).

FIG. 3C illustrates a representative determination of an updated touch-extension position using Equation 3. With reference to FIGS. 1-3B, the initial touch location 356a may be identified as the center point 356a of the ellipse (e.g., 300) best fitting the boundary of the initial touch area 310. Updated touch location 356b may be identified following detecting dragging of the user's finger across the touchscreen interface, and vector 362 may represent a path between the initial touch location 356a and the updated touch location 356b. The vector 362 may correspond to f−e in Equation 3. In various embodiments, calculating the vector 362 may be performed by subtracting a vector representing the initial touch position 356a (e.g., a vector from the vector origin point to the initial touch position 356a) from a vector representing the updated touch position 356b (e.g., a vector from the vector origin point to the updated touch position 356b).

In various embodiments, the initial touch-extension position 358a may be represented by a vector from the vector origin point to the initial touch-extension position 358a, corresponding to gin Equation 3. In order to compute the updated touch-extension position 358b, the vector 362 may be multiplied by a scalar. The resultant vector 364 corresponds to (f−e)*k in Equation 3. Therefore, the updated touch-extension position 358b may be determined by adding the vector 364 to the initial touch-extension position 358a. That is, the updated touch-extension position 358b may be represented by a vector from the vector origin point to the updated touch-extension position 358b, which may correspond to the calculation in Equation 3 of g+(f−e)*k.

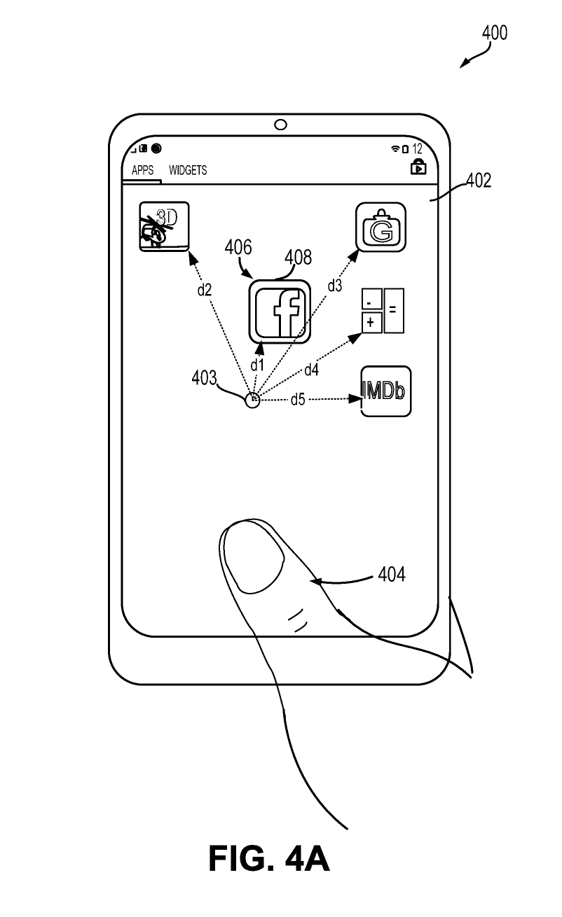

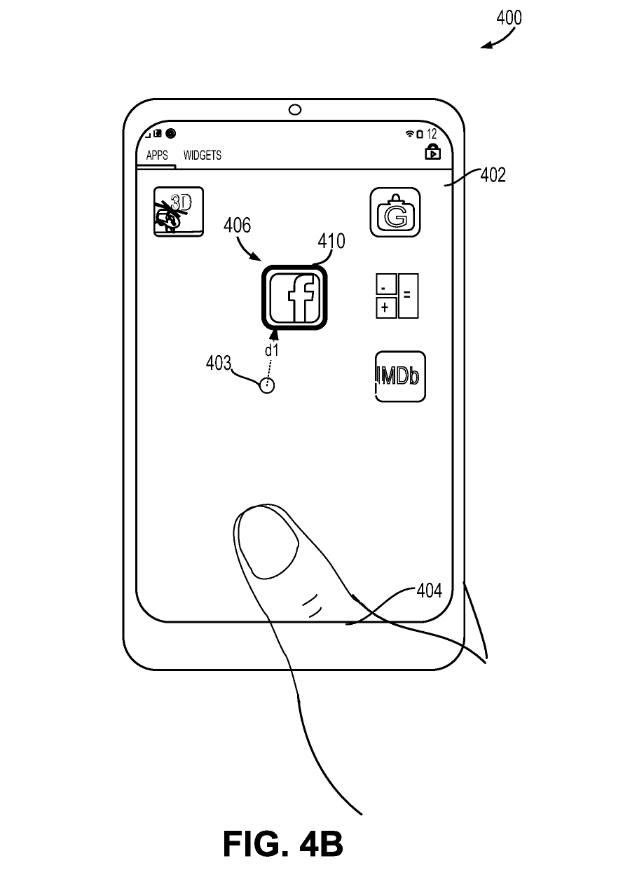

FIGS. 4A and 4B illustrate a mobile device 400 operating in the expanded reach mode. The mobile device 400 may include a touchscreen display 402 that includes a GUI. In the expanded reach mode, a cursor may be controlled by maintaining a touch on the touchscreen display 402.

In various embodiments, the expanded reach mode may be activated by performing a triggering gesture or other input on the touchscreen display 402, and maintaining the contact between the finger 404 and touchscreen display 402. The user may wish to activate the expanded reach mode when the user intends to operate GUI elements on a region of the touchscreen display 402 that is not easily reachable by the finger 404. Once the expanded reach mode is activated and a touch-extension position is identified, the user may control the location of the cursor by rotating the finger 404 and moving the position of the finger 404 on the touchscreen display. In some embodiments, the position of the cursor (or other indication of the extension of the touch) may be shown by displaying another visual indication, such as an icon 403, on the touchscreen display.

In various embodiments, a predetermined shape or gesture may be designated as a trigger for activating the expanded reach mode on the mobile device. For example, in some embodiments, a user may activate the expanded reach mode by touching anywhere on the touchscreen using the side of the user's finger 404 (e.g., thumb). In other embodiments, the user may alternatively trigger the expanded reach mode by drawing a shape, or performing a gesture (e.g., a swipe, pinch, etc.) on the touchscreen. In some embodiments, a user may additionally or alternatively trigger the expanded reach mode by applying a sufficient amount of force at any area on the touchscreen display 402. For example, the expanded reach mode may be activated in response to detecting a touch input with an amount of pressure that is above a threshold value.

Depending on the user's settings and the mobile device configurations, the touchscreen display 402 may include any of a number of selectable GUI elements, which may be arranged randomly or in a pattern or order.

Once in the expanded reach mode, a cursor (or other indication of the extension of the touch) may be activated, the position of which may be indicated on the touchscreen. In some embodiments, the position of the cursor may be shown by displaying a visible indication (e.g., icon 403 or other visual cue) on the touchscreen display, while in some embodiments no visual indication is provided. While in the expanded reach mode, a nearest-neighbor approach may be used to select a GUI element having an edge (i.e., border) that is closest to the current touch-extension position. In various embodiments, a distance between the current touch-extension position and the nearest edge point of each selectable GUI element may be computed. For example, on the touchscreen display 402, such distance values are shown as d1 through d5. In various embodiments, the selectable GUI element that is associated with the shortest distance between the object and the cursor may be identified for selection. For example, on the touchscreen display 402, the shortest distance value may be d1, and therefore the corresponding selectable GUI element may be identified as a GUI element 406 nearest to the cursor for selection. In various embodiments, a first selection indicator may be displayed with respect to the nearest GUI element (e.g., GUI object nearest to the cursor). The first selection indicator may be, for example, a border 408 surrounding the GUI element 406.

In various embodiments, a second selection indicator may be displayed once the nearest GUI element has been selected for longer than a threshold duration of time (e.g., 500 ms). The second selection indicator may be, for example, another new border or shape, an enhancement to the existing first selection indicator, etc. As illustrated in FIG. 4B, the touchscreen 402 may display a thickened border 410 surrounding the nearest GUI element 406 after the first selection indicator 408 has been continuously applied for longer than the threshold time.

In some embodiments, the scaling factor k that may be utilized in the above touch-extension position calculations may be calibrated to adjust the amount of change in touch-extension position per movement of the user's finger. In some embodiments, the user may receive constant visual feedback from the touchscreen display in the form of the change in location of the displayed cursor icon. Therefore, the user may adjust the relative force and/or motion being employed by the user to achieve desired results. In some embodiments, the mobile device may be configured to perform some training with a user as part of a user configuration procedure in order to detect properties of the user's finger size and pressing activity. In this manner, the scaling factor may be adjusted to accommodate the relative input characteristics of each user.

The mobile device may store each user-customized scaling factor for future use for the user (e.g., within a user profile), and may evolve the user's scaling factor over time as details regarding particular touch patterns are collected. In some embodiments, the manufacturer may specify preset maximum and minimum scaling factors (i.e., a scaling factor range) based on the size of the particular display and the relative size and strength of an average human touch input. While these ranges may be used initially, some embodiments may provide for eventual customization of a scaling factor over time based on user interactions, effectively replacing a generalized scaling factor with specifically developed values. Such customizations may also be made available for the sensitivity and/or speed of the cursor movement.

In some embodiments, the user may manually adjust parameters, such as the scaling factor k. In some embodiments, once the desired GUI element is selected on the GUI, an operation may be performed with respect to the selected GUI element (i.e., nearest GUI element to the touch-extension position).

In some embodiments, the operation performed with respect to the selected GUI element e may be activation of an icon that causes an application (e.g., a program, an app, a game, etc.) to be launched.

In some embodiments, the expanded reach mode may be terminated in response to detecting a particular input to the touchscreen display 402, such as the user's finger being removed from the touchscreen display prior to the second selection indicator being applied.

In various embodiments, the processor may detect a sudden decrease in touch pressure caused by the ending of the touch, which may indicate that the user intends to execute a GUI operation. In some embodiments, the expanded reach mode may be deactivated based on receiving additional user inputs via the GUI. For example, in an embodiment the user may deactivate (i.e., exit) the expanded reach mode by moving the finger to an area (e.g., an activation area) on the GUI, and removing the finger from the touchscreen display 410 prior to the second selection indicator being applied to a nearest GUI element.

In some embodiments, the expanded reach mode may be automatically deactivated after performing an operation (e.g., selection of an application or item). In some embodiments, the user may additionally or alternatively deactivate the expanded reach mode by performing a particular recognized gesture on the touchscreen display 410. For example, the processor may be configured to exit the expanded reach mode e in response to a double click, a swipe left, a swipe right, a combination thereof, etc. on the touchscreen display 402.

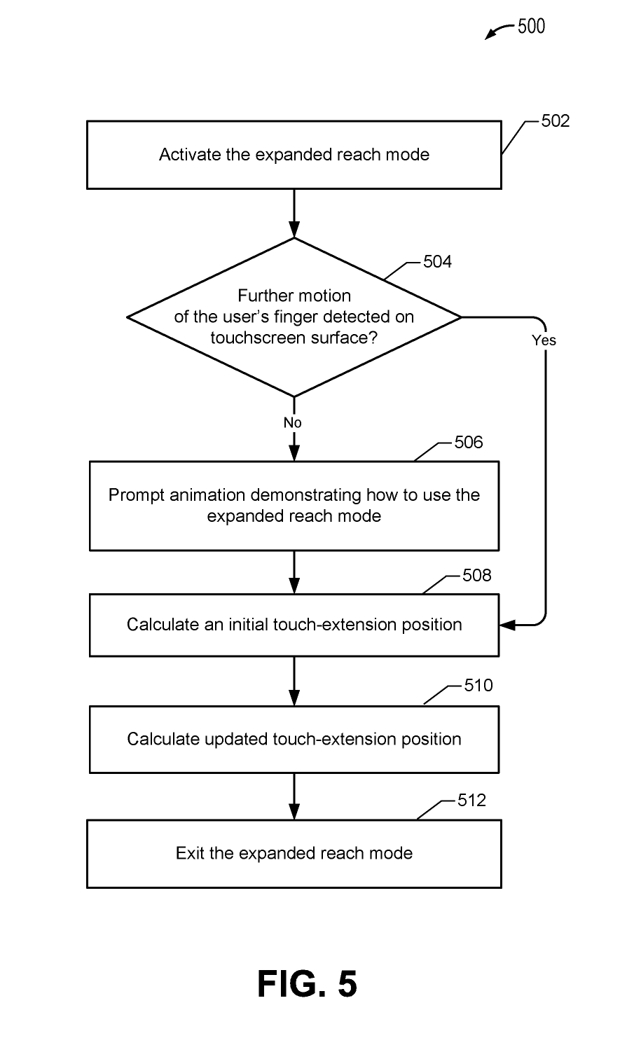

FIG. 5 illustrates a method 500 for implementing an expanded reach mode on a mobile device according to some embodiments. The operations of method 500 may be implemented by one or more processors of a mobile device (e.g., 100, 150), such as a general purpose processor (e.g., 152). In various embodiments, the operations of the method 500 may be implemented by a separate controller (not shown) that may be coupled to memory (e.g., 154), the touchscreen (e.g., 115), and to the one or more processors (e.g., 110).

In block 502, the expanded reach mode may be activated by a processor of the mobile device. In some embodiments, the expanded reach mode may be activated by the processor upon detection of a triggering gesture. Once the triggering gesture is detected, the processor may determine whether further motion of the user's finger on the touchscreen surface is detected in determination block 504.

In some embodiments, in response to determining that no further motion of the user's finger on the touchscreen surface is detected (i.e., determination block 504=“No”), the processor may prompt an animation to play that demonstrates to the user how to utilize the cursor in the expanded reach mode in block 506.

Following the animation demonstrating how to utilize the cursor in the expanded reach mode in block 506, or in response to determining that further motion of the user's finger on the touchscreen surface is detected (i.e., determination block 504=“Yes”), the processor may calculate an initial touch-extension position in block 508. A visual indication of the initial touch-extension position, such as an icon, may be displayed on the touchscreen. As described, the initial touch-extension position may be calculated by identifying an initial touch location on the touchscreen display, and adding a predetermined offset distance in the y-axis direction. In some embodiments, the initial touch location and the initial touch-extension position may each be represented as a vector from a vector origin point (e.g., the center of the touchscreen, a point on a corner or bottom of the touchscreen, etc.).

In block 510, the processor may calculate an updated touch-extension position. A visual indication of the updated touch-extension position, such as re-positioning a corresponding icon to the track the updated touch-extension position, may be provided on the touchscreen. As described, the updated touch-extension position may be calculated based on an updated touch location resulting from movement of the user's finger across the surface of the touchscreen. In some embodiments, the updated touch-extension position may be calculated by the processor by evaluating the expression g+((f−e)*k) (Equation 3), which yields a vector to the updated position of the cursor/icon (e.g., a vector from the vector origin point (e.g., the center of the touchscreen, a point on a corner or bottom of the touchscreen, etc.) to the current location of the cursor icon on the touchscreen display).

Updated positions of the cursor on the touchscreen display may be calculated continuously until the processor exits the single handed-use mode in block 512, such as by deactivating the expanded reach mode. In some embodiments, the expanded reach mode may be automatically deactivated by the processor after a GUI operation, such as activation of a selected GUI element. For example, the user may activate a selected GUI element by ending a touch event (e.g., finger lift) after the GUI element has been continuously selected for a predetermined time threshold. The expanded reach mode may also be deactivated by the processor upon detecting that the user has requested a deactivation. For example, such deactivation request may involve the processor may detecting that the user has ended a touch event (e.g., finger lift) prior to a selected GUI element being selected for the predetermined time threshold.

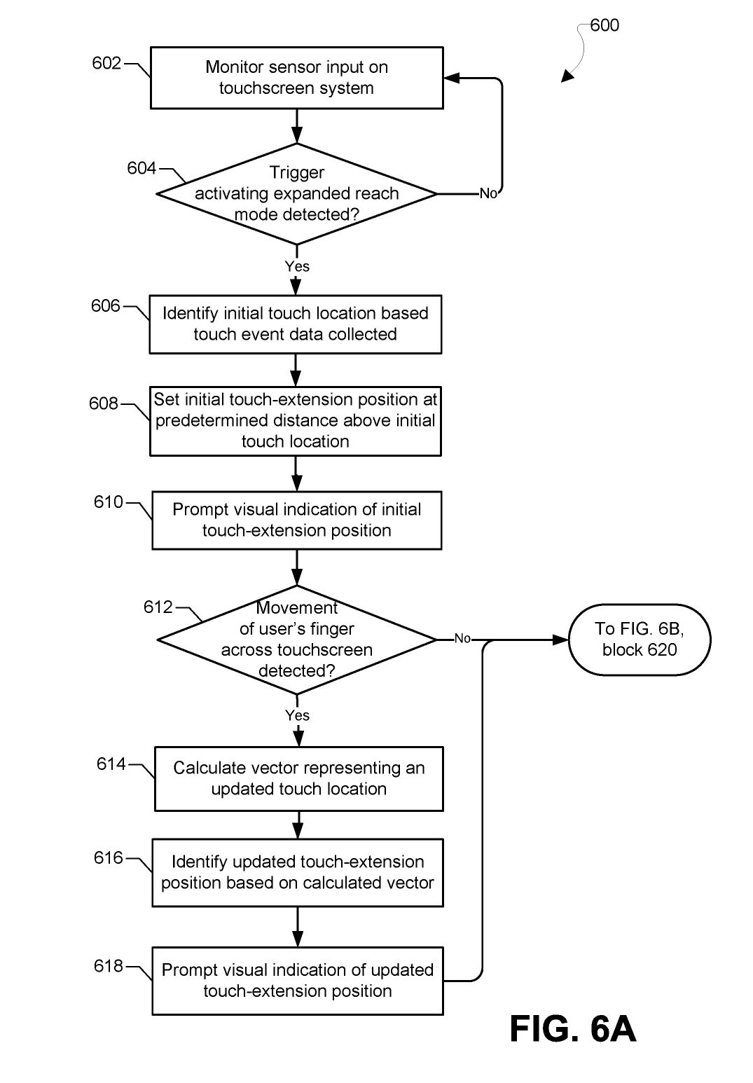

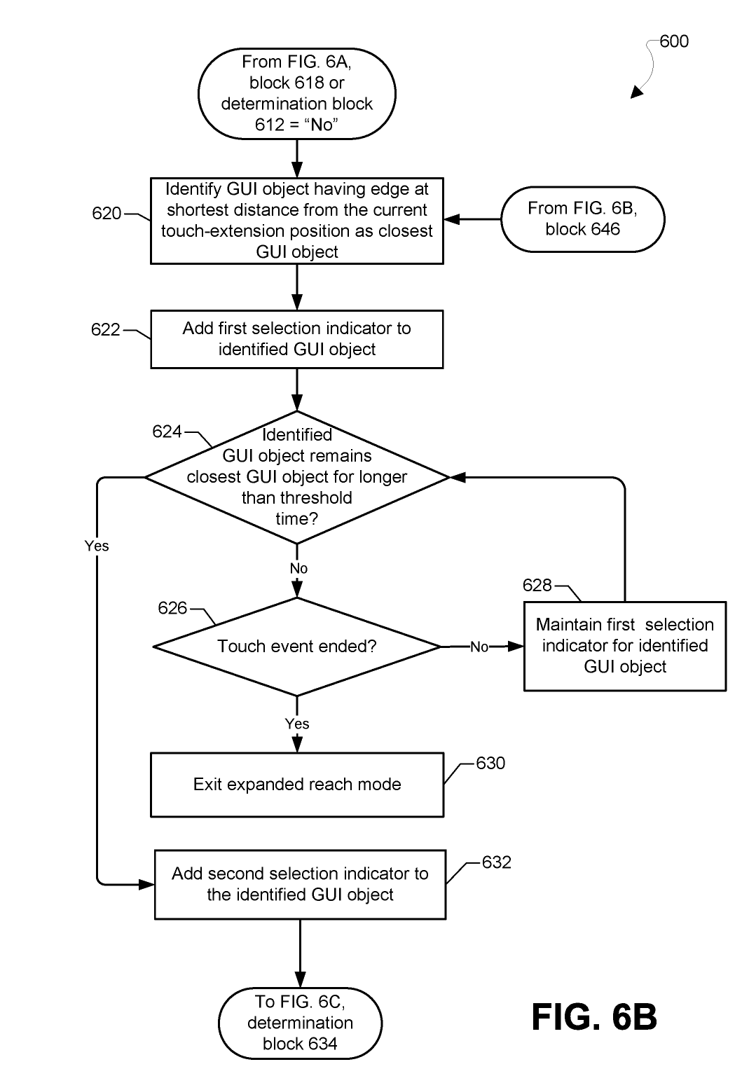

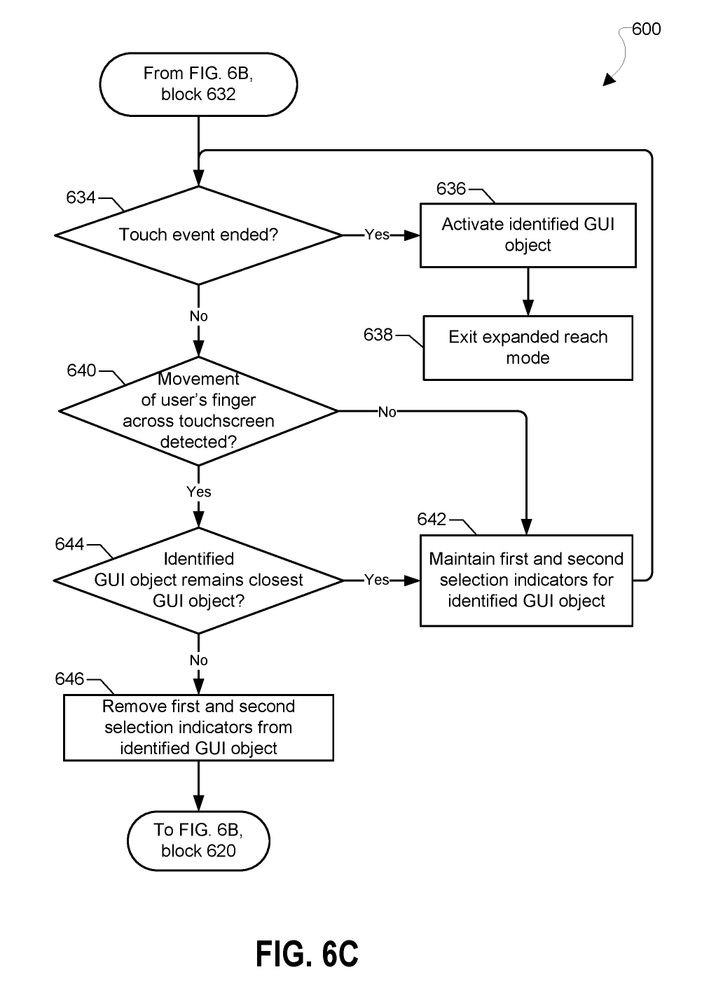

FIGS. 6A-6C illustrate a method 600 for providing a cursor interface in an expanded reach mode according to various embodiments. With reference to FIGS. 1-6C, in various embodiments, the operations of method 600 may be implemented by one or more processors (e.g., 110) of a computing (e.g., 100, 150), such as a general purpose processor(s) (e.g., 110, 152). In various embodiments, the operations of the method 600 may be implemented by a separate controller (not shown) that may be coupled to memory (e.g., 154), the touchscreen (e.g., 115) and to the one or more processor 152.

In block 602, a processor of the mobile device may monitor touch sensor input on the mobile device (e.g., input to the touch sensor(s) 158, received via the touchscreen I/O controller 162).

In determination block 604, the processor may determine whether a trigger activating the expanded reach mode is detected. Such trigger may be, for example, input of a particular gesture using one or more finger, or pressing a specific position, on the touchscreen display. So long as no trigger of the expanded reach mode is detected (i.e., determination block 604=“No”), the processor may continue to monitor the touch sensor input on the mobile device in block 602.

In response to determining that a trigger to activating the expanded reach mode is detected (i.e., determination block 604=“Yes”), the processor may identify an initial touch location based on touch event data collected in block 606. The touch event may be, for example, input detected on the touch-sensitive surface through touch sensor(s) (e.g., 158). In some embodiments, touch data may be sensed/measured by the touchscreen display 115, and may include position, size, and shape of input defining a touch area associated with the input. In some embodiments, the touch data may include pressure being applied by the user's finger (if using a pressure-sensitive device), etc. In some embodiments, the initial touch location may be identified as a center point of an ellipse function best fit to the border of the touch area in the touch event. In other embodiments, the initial touch location may be identified as a point within the touch area at which the user applies the maximum pressure.

In block 608, the processor may set the initial touch-extension position at a predetermined offset above the initial touch location. In various embodiments, the predetermined offset may be a customizable distance (e.g., 3 cm) from the initial touch location in the y-axis direction.

In block 610, the processor may cause a visual indication of the initial touch-extension position to be shown on the touchscreen display. In some embodiments, the visual indication may be a shape (e.g., a dot, star, square, etc.) that tracks the location of the initial touch-extension position. In some embodiments, the visual indication may be a gradient across the entire display that shows the location of the initial touch-extension position (e.g., color, background pattern, etc.).

In determination block 612, the processor may determine whether movement of the user's finger across the touchscreen is detected.

In response to determining that movement of the user's finger is detected (i.e., determination block 612=“Yes”), the processor may calculate a vector representing an updated touch location in block 614.

In block 616, the processor may identify an updated touch-extension position based on the calculated vector. In various embodiments, identifying an updated touch-extension position may be performed by scaling the magnitude of the calculated vector and applying the scaled distance to the initial touch-extension position. The updated touch-extension position may be calculated by applying a scaling factor to the calculated vector, with the resultant vector added to a vector from the vector origin point (e.g., center of the touchscreen, corner of the touchscreen, etc.) to the initial touch-extension position.

In block 618, the processor may prompt a visual indication of the updated touch-extension position on the touchscreen display. For example, if the visual indication is display of an icon (e.g., a dot) representing the touch-extension position, the location of the icon on the display may be changed to track the updated touch-extension position.

In response to determining that movement of the user's finger is not detected (i.e., determination block 612=“No”), the processor may identify a GUI object having an edge that is the shortest distance from the current touch-extension position as the closest GUI object in block 620 (FIG. 6B).

In block 622, the processor may add a first selection indicator to the identified GUI object. Such first selection indicator may be, for example, a shape or border drawn around the identified GUI object.

In determination block 624, the processor may determine whether the identified GUI object has remained the closest GUI object for longer than a time threshold (e.g., 500 ms).

In response to determining that the identified GUI object has not remained the closest GUI object for longer than the time threshold (i.e., determination block 624=“No”), the processor may determine whether the touch event has ended in determination block 626. In various embodiments, the end of the touch event may be identified by detecting that the user's finger has been removed from the touchscreen display. In response to determining that the touch event has not ended (i.e., determination block 626=“No”), the processor may maintain the first selection indicator for the identified GUI object in block 628.

In response to determining that the touch event has ended (i.e., determination block 626=“Yes”), the processor may exit the expanded reach mode in block 630. In various embodiments, exiting the expanded reach mode may involve returning to normal input and output operations on the touchscreen display, as well as removing the indication of the touch-extension position and any selection indicators applied to the GUI object(s).

In response to determining that the identified GUI object has remained the closest GUI object for longer than the time threshold (i.e., determination block 624=“Yes”), the processor may add a second selection indicator to the identified GUI object in block 632. In some embodiments, adding the second selection indicator may involve altering or enhancing the first selection indicator (e.g., thickening a border or shape around the GUI object). In some embodiments, adding the second selection indicator may involve adding a different indicator to the identified GUI object (e.g., a different shape or border).

In determination block 634 (FIG. 6C), the processor may determine whether the touch event has ended. In response to determining that the touch event has ended (i.e., determination block 634=“Yes”), the processor may activate the identified GUI object in block 636. Activating the identified GUI object may involve, for example, launching an application associated with the GUI object, opening a new screen or document, etc.). The processor may exit the expanded reach mode in block 638.

In response to determining that the touch event has not ended (i.e., determination block 634=“No”), the processor may determine whether movement of the user's finger across the touchscreen is detected in determination block 640. In response to determining that movement of the user's finger across the touchscreen is not detected (i.e., determination block 640=“No”), the processor may maintain the first and second selection indicators for the identified GUI object in block 642, and continue to determine whether the touch event has ended determination block 634.

In response to determining that movement of the user's finger across the touchscreen is detected (i.e., determination block 640=“Yes”), the processor may determine whether the identified GUI object is still the closest GUI object in determination block 644.

In response to determining that the identified GUI object is still the closest GUI object (i.e., determination block 644=“Yes”), the processor may maintain the first and second selection indicators for the identified GUI object block 642.

In response to determining that the identified GUI object is not still the closest GUI object (i.e., determination block 644=“No”), the processor may remove the first and second selection indicators from the identified GUI object in block 646. The processor may again identify the GUI object having an edge a shortest distance from the current touch-extension position as the closest GUI object in block 620 FIG. 6B), and maintain the first and second selection indicators for the identified GUI object block 642.

Utilization of embodiments of the disclosure described herein enables a user to interact with elements of a GUI displayed on a region of a touchscreen display that is difficult to directly reach by implementing a cursor in an expanded reach mode. The cursor may enable touches and movements of a user finger to easily reach all areas of a touchscreen display, thereby facilitating operation of a mobile device using one hand Further, the cursor may be configured to automatically select the nearest selectable GUI element on the touchscreen display, reducing the amount of movement required by the user's finger. Various embodiments have been described in relation to a mobile device and/or mobile device, but the references to a mobile device and/or smartphone are merely to facilitate the descriptions of various embodiments and are not intended to limit the scope of the disclosure or the claims.

Various implementations of a cursor interface according to various embodiments may be implemented as software, firmware, hardware, combinations thereof, etc. In one embodiment, the previous described functions may be implemented by one or more processors (e.g., processor(s) 110) of a mobile device 100 to accomplish the operations and functions of the methods of FIGS. 5 and 6.

The various illustrative logical blocks, modules, engines, circuits, and algorithm operations described in connection with the embodiments disclosed herein may be implemented as electronic hardware, computer software, or combinations of both. To clearly illustrate this interchangeability of hardware and software, various illustrative components, blocks, modules, engines, circuits, and operations have been described above generally in terms of their functionality. Whether such functionality is implemented as hardware or software depends upon the specific application and design constraints imposed on the overall system. Skilled artisans may implement the described functionality in varying ways for each application, but such implementation decisions should not be interpreted as causing a departure from the scope of the claims.

The various illustrative logical blocks, modules, and circuits described in connection with the embodiments disclosed herein may be implemented or performed with a general purpose processor, a DSP, an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of mobile devices, e.g., a combination of a DSP and a microprocessor, a plurality of microprocessors, one or more microprocessors in conjunction with a DSP core, or any other such configuration.

The operations of a method or algorithm described in connection with the various embodiments may be implemented directly in hardware, in a software

Attorney Docket No. 164774 module executed by a processor, or in a combination of the two. If implemented in software as a computer program product, the functions or modules may be stored on as one or more instructions or code stored on a non-transitory computer-readable medium. A non-transitory computer-readable medium may include any available media that can be accessed by a computer. By way of example, and not limitation, such non-transitory computer-readable media may include Random Access Memory (RAM), flash memory, Read Only Memory (ROM), Erasable Programmable Read Only Memory (EPROM), Electrically Erasable Programmable Read Only Memory (EEPROM), registers, hard disk, a removable disk, a Compact Disc Read Only Memory (CD-ROM), or any other medium that can be used to carry or store program code in the form of processor-executable instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the principles and novel features disclosed herein.

What is claimed is:

1. A method for implementing a cursor interface on a touchscreen of a mobile device, comprising:
detecting a user input to the touchscreen triggering activation of an expanded reach mode;
identifying a touch location based on a touch event on the touchscreen;
identifying a selectable graphical user interface (GUI) object having an edge closest to a touch-extension position that is based on the identified touch location;
selecting the identified GUI object as a closest GUI object and displaying a first selection indicator in association with the identified GUI object;
determining whether the identified GUI object has remained the closest GUI object for longer than a predetermined time threshold; and
enabling activation of the identified GUI object in response to determining that the identified GUI object has remained the closest GUI object for longer than a predetermined time threshold.

2. The method of claim 1, further comprising:
determining whether the touch event has ended in response to determining that the identified GUI object has not remained the closest GUI object for longer than the predetermined time threshold; and
exiting the expanded reach mode in response to determining that the touch event has ended.

3. The method of claim 2, further comprising:
maintaining the first selection indicator displayed in association with the identified GUI object in response to determining that the touch event has not ended.

4. The method of claim 1, further comprising projecting an indication of the touch-extension position on the touchscreen, wherein projecting the indication comprises at least one of:
displaying a visible cursor on the touchscreen at the touch-extension location; or
displaying the first selection indicator in association with the identified GUI object.

5. The method of claim 1, wherein enabling activation of the identified GUI object comprises:
displaying a second selection indicator in association with the identified GUI object;
determining whether the touch event has ended; and
in response to determining that the touch event has ended:
launching an action associated with the identified GUI object; and
automatically exiting the expanded reach mode.

6. The method of claim 5, wherein the first selection indicator associated with the identified GUI object comprises a border surrounding the identified GUI object.

7. The method of claim 6, wherein displaying the second selection indicator in association with the identified GUI object comprises displaying a thicker version of the first selection indicator.

8. The method of claim 6, wherein displaying the second selection indicator in association with the identified GUI object comprises displaying a shape surrounding the identified GUI object, wherein the shape is different than that of the border of the first selection indicator.

9. The method of claim 1, wherein identifying the touch location comprises:
identifying an initial touch location;
determining whether movement of a user's finger across the touchscreen is detected; and
identifying an updated touch location in response to determining that movement of a user's finger across the touchscreen is detected.

10. The method of claim 9, further comprising projecting an indication of the touch-extension position on the touchscreen by:
calculating an initial touch-extension position at a predetermined offset from the initial touch location;
calculating a vector representing updated touch location; and
calculating an updated touch-extension position by applying the vector and a scaling factor to the initial touch-extension position.

11. The method of claim 10, wherein the predetermined offset from the initial touch location comprises 3 cm toward the top of the mobile device.

12. The method of claim 10, wherein identifying the initial touch location comprises:
identifying a touch area associated with the detected touch event;
computing an equation of a shape that best fits a border of the touch area; and
identifying a center point of the shape that best fits the border of the touch area.

13. The method of claim 1, wherein the first selection indicator comprises a visual indication displayed on the touchscreen.

14. The method of claim 13, wherein the visual indication displayed on the touchscreen comprises an icon that tracks the touch-extension position on the touchscreen.

15. The method of claim 1, further comprising:
determining whether movement of a user's finger across the touchscreen is detected upon activation of the expanded reach mode; and
playing, on the touchscreen, an animation demonstrating how to control the indication of the touch extension in the expanded reach mode in response to determining that motion of the user's finger across the touchscreen is detected.

16. A computing device, comprising:
a touchscreen;
a memory; and
a processor coupled to the touchscreen and the memory, wherein the processor is configured with processor-executable instructions to perform operations comprising:
detecting a user input to a touchscreen triggering activation of an expanded reach mode;
identifying a touch location based on a touch event on the touchscreen;
identifying a selectable graphical user interface (GUI) object having an edge closest to the touch-extension position, wherein the touch-extension position is based on the identified touch location;
selecting the identified GUI object as a closest GUI object and displaying a first selection indicator in association with the identified GUI object;
determining whether the identified GUI object has remained the closest GUI object for longer than a predetermined time threshold; and
enabling activation of the identified GUI object in response to determining that the identified GUI object has remained the closest GUI object for longer than a predetermined time threshold.

17. The computing device of claim 16, wherein the processor is configured with processor-executable instructions to perform operations further comprising:
determining whether the touch event has ended in response to determining that the identified GUI object has not remained the closest GUI object for longer than the predetermined time threshold; and
exiting the expanded reach mode in response to determining that the touch event has ended.

18. The computing device of claim 17, wherein the processor is configured with processor-executable instructions to perform operations further comprising:
maintaining the first selection indicator displayed in association with the identified GUI object in response to determining that the touch event has not ended.

19. The computing device of claim 16, wherein the processor is configured with processor-executable instructions to perform operations further comprising:
projecting an indication of the touch-extension position on the touchscreen,
wherein the processor is configured with processor-executable instructions to perform operations such that projecting the indication comprises at least one of:
displaying a visible cursor on the touchscreen at the touch-extension position; or
displaying the first selection indicator in association with the identified GUI object.

20. The computing device of claim 16, wherein the processor is further configured with processor-executable instructions to perform operations such that enabling activation of the identified GUI object comprises:
displaying a second selection indicator in association with the identified GUI object;
determining whether the touch event has ended; and
in response to determining that the touch event has ended:
launching an action associated with the identified GUI object; and
automatically exiting the expanded reach mode.

21. The computing device of claim 20, wherein the first selection indicator associated with the identified GUI object comprises a border surrounding the identified GUI object.

22. The computing device of claim 21, wherein the processor is configured with processor-executable instructions to perform operations such that displaying the second selection indicator in association with the identified GUI object comprises displaying a thicker version of the first selection indicator.

23. The computing device of claim 21, wherein the processor is configured with processor-executable instructions to perform operations such that displaying the second selection indicator in association with the identified GUI object comprises displaying a shape surrounding the identified GUI object, wherein the shape is different than that of the border of the first selection indicator.

24. The computing device of claim 16, wherein the processor is configured with processor-executable instructions to perform operations such that identifying the touch location comprises:
identifying an initial touch location;
determining whether movement of a user's finger across the touchscreen is detected; and
identifying an updated touch location in response to determining that movement of a user's finger across the touchscreen is detected.

25. The computing device of claim 24, wherein the processor is configured with processor-executable instructions to perform operations further comprising projecting an indication of the touch-extension position on the touchscreen by:
calculating an initial touch-extension position at a predetermined offset from the initial touch location;
calculating a vector representing updated touch location; and
calculating an updated touch-extension position by applying the vector and a scaling factor to the initial touch-extension position.

26. The computing device of claim 25, wherein the predetermined offset from the initial touch location comprises 3 cm toward the top of the computing device.

27. The computing device of claim 25, wherein the processor is configured with processor-executable instructions to perform operations such that identify the initial touch location comprises:
identifying a touch area associated with the touch event;
computing an equation of a shape that best fits a border of the touch area; and
identifying a center point of the shape that best fits the border of the touch area.

28. The computing device of claim 16, wherein the first selection indicator comprises a visual indication displayed on the touchscreen.

29. A computing device, comprising:
a touchscreen;
means for detecting a user input to the touchscreen triggering activation of an expanded reach mode;
means for identifying a touch location based on a touch event on the touchscreen;
means for identifying a selectable graphical user interface (GUI) object having an edge closest to a touch-extension position that is based on the identified touch location;
means for selecting the identified GUI object as a closest GUI object and displaying a first selection indicator in association with the identified GUI object;
means for determining whether the identified GUI object has remained the closest GUI object for longer than a predetermined time threshold; and
means for enabling activation of the identified GUI object in response to determining that the identified GUI object has remained the closest GUI object for longer than a predetermined time threshold.

30. A non-transitory processor-readable storage medium having stored thereon processor-executable instructions configured to cause a processor of a computing device configured with a touchscreen to perform operations comprising:
detecting a user input to the touchscreen triggering activation of an expanded reach mode;
identifying a touch location based on a touch event on the touchscreen;
identifying a selectable graphical user interface (GUI) object having an edge closest to a touch-extension position that is based on the identified touch location;
selecting the identified GUI object as a closest GUI object and displaying a first selection indicator in association with the identified GUI object;
determining whether the identified GUI object has remained the closest GUI object for longer than a predetermined time threshold; and
enabling activation of the identified GUI object in response to determining that the identified GUI object has remained the closest GUI object for longer than a predetermined time threshold.
